(19) United States
(12) Patent Application Publication
(10) Pub. No.: US 2005/0288072 A1
(43) Pub. Date: Dec. 29, 2005

(54) Foldable device

(75) Inventor: Pasi Kemppinen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/142,843

(22) Filed: May 31, 2005

(30) Foreign Application Priority Data
Jun. 1, 2004 (FI) 20045203

(51) Int. Cl. H04M 1/00

(52) U.S. Cl. 455/575.3

(57) ABSTRACT

An electronic device has at least a first frame part (1a), a second frame part (1b) and a third frame part (1c), which are movable in relation to each other. The first, second and third frame parts are arrangable in at least two positions: (a) a closed position with the frame parts substantially on top of each other, and (b) an open position with the second frame part (1b) moved at least partly away from the first frame part (1a), and the third frame part (1c) moved at least partly away from the first frame part (1a). In the second, open position the frame parts (1) of the device are arranged to be positioned in the vicinity of each other. In addition, the invention relates to a method for controlling the user interface of an electronic device as well as a computer program.

### CROSS-REFERENCE TO RELATED APPLICATIONS

This application claims priority under 35 USC §119 to Finnish Patent Application No. 20045203 filed on Jun. 1, 2004.

### FIELD OF THE INVENTION

The invention relates to an electronic device, which comprises at least three frame parts arranged movable in relation to each other. In addition, the invention relates to a corresponding method and computer program.

### BACKGROUND OF THE INVENTION

The use of different kinds of portable and hand-held devices, such as, for example, mobile phones and PDA-devices, becomes more versatile with functions added to the devices. This has brought along new kinds of challenges for the use and design of the devices. In addition, the users want solutions that are easy to use and versatile for their everyday use.

The user controls the operation of the device via a user interface of the device, i.e., among other things, a keypad and a display. Because of the differences between the functions of the device, the use of one user interface is not necessarily the best solution of using different functions. In some known device solutions, different user interfaces have been used, by means of which the user may use the different functions of the device. For example, in the Nokia Communicator there is a simple user interface for the basic functions, such as, for example, phone calls, and a more extensive user interface for using the more versatile applications. A more extensive user interface, which offers a larger display and a more versatile keypad, can be taken into use by “opening” the device.

Published U.S. patent application U.S. 2005/0017953, corresponding to International Publication No. WO03/054672, describes a phone structure, where two foldable wings are attached on opposite sides of the frame part of the device. The wings fold on top of each other over the frame part and open to both sides of the frame part. Different parts of the user interface are suggested to be placed in said wings and frame part, such as buttons and displays.

In known structures offering a more compact or extensive user interface, the structures of different user interfaces cannot be utilized in an effective manner in different user interface states, such as displays or keypads. Because of this, several keypads and displays must typically be arranged in the devices.

### SUMMARY OF THE INVENTION

The main purpose of the present invention is to provide a device structure, which is small in a closed position and easily portable and which when opened offers a versatile user interface. In addition, the invention enables the utilization of partly the same user interface structures in different usage situations.

The device according to the invention comprises at least three frame parts arranged in movable relation to each other, which are attached to each other in such a manner that when the device is in a closed position, the frame parts of the device are on top of each other and/or within each other, and when the device is open, the frame parts set next to each other. The frame parts can set within a short distance from each other or they may touch each other.

In an embodiment of the device, a second part and a third part of the frame parts are connected to a first part in such a manner that the third part can be positioned on top of the first part when the device is closed, and the second part can be positioned under the first part, i.e. can be positioned on the opposite side of the first part than that of the third part. In other words, in a closed position, the second part is positioned in between the first part and the third part. In addition, the frame parts touch each other when the device is open. When opening a device according to an embodiment, the parts set next to each other in a manner that resembles a three-leafed clover.

In an embodiment the opened and/or closed frame parts lock to each other by means of locking means, such as, for example, magnets. In another embodiment, in turn, the position of the frame parts is detected by means of a position detection means.

In an embodiment of the invention the second frame part and the third frame part are connected to the first frame part by means of hinge structures in such a manner that the angle between the axis lines of the hinge structures is 120 degrees. Thus, the angle between the opening directions of the first frame part and the second frame part is, in turn, 60 degrees.

In an embodiment the frame parts are uniform is such a manner that the sides setting on top of each other in the closed form correspond substantially to each other in their form. Thus, the appearance of the closed device corresponds substantially to the form of only one part.

The structures performing the different functions of the device can be positioned in different parts of the device. In an embodiment according to the invention the data processing is performed in one part and a power supply system, such as, for example, a battery, is positioned in the second part. The required power is transferred from the second part to the other parts via suitable lead structures, which may be a part of the opening structure and/or a flexible lead structure. The other signals are transferred between different parts in a similar manner.

In an embodiment of the invention, the two frame parts form, when open, a keypad assembly and in another embodiment the frame parts form a touch screen when open.

In an embodiment of the invention, at least in one frame part there are actuators, by means of which it is possible to control the device when the device is in a closed position. In an embodiment the device opens in such a manner that the surface comprising the above-mentioned actuators remains visible.

The invention enables the use of different display and keyboard combinations in a small device, which is small and easily portable when closed. An embodiment enables the placement of a user-friendly qwerty-keyboard in a small-sized phone. Also, the use of two displays or even three displays as touch screens is possible. It is also possible to arrange actuators in one of more parts on both sides of the part.

It is also possible to use the surfaces of different parts of the device for other purposes than those directly related to the control of the device. These kinds of applications include, for example, different decorations, games and other solutions connected to personalizing.

The structure according to the invention does not depend on how the use of the function of the device and the position of the structure of the device are connected to each other. In an embodiment the functions of the device can be used with a simple user interface when the device is in a closed position and a more versatile user interface can be used by opening the device. In a phone according to an embodiment of the invention, speaking on the phone is possible when one part of the phone has been opened.

The user interface of a device according to an embodiment of the invention is activated by opening the device from the closed position to the open position. Thus, for example, by opening and/or closing the device the displays and/or keypads are set on or off and/or visible or hidden. The effect achieved by opening and/or closing the device depends naturally on the device and its usage applications, which may be connected to, for example, a phone call, writing, reading, playing, i.e., whatever the user can do with his/her device.

The solution according to the invention can be used in different devices, such as, for example, portable and hand-held devices. For example, the device can be a mobile phone, a PDA, a communication device and/or a game device. Generally, the invention is well suited for objects, where the device is desired to be small in size, such as when carrying it, and sometimes, in turn, to have relatively large area, for example in order to direct functions and/or display information. In some embodiments the foldable structure also forms a protective structure for the means of the device when the device is not opened into the usage position. Thus, for example, the keypad, display and/or the camera objective can be protected during transportation.

### DESCRIPTION OF THE DRAWINGS

In the following, the invention will be described in more detail with reference to the appended principle drawings, in which

FIG. 1 shows an embodiment of the device according to the invention in an open position,

FIG. 2 shows a device according to the invention in a closed position,

FIG. 3 shows the device according to FIG. 2 in a side view from the direction of the X,

FIGS. 4 to 9 show some phases connected to opening the device according to the invention,

FIG. 10 shows another embodiment of the invention in the open position,

FIG. 11 shows the device according to FIG. 10 in the closed position,

FIG. 12 shows a third embodiment of the invention in the open position,

FIG. 13 shows the device according to FIG. 12 in the closed position,

FIGS. 14 to 17 show a fourth embodiment of the invention in different positions,

FIG. 18 shows the control principle of the device according to an embodiment as a flow chart, and

FIGS. 19 to 24 show some phases connected to opening the device according to the invention.

### DETAILED DESCRIPTION OF THE INVENTION

For the sake of clarity, the figures only show the details necessary for understanding the invention. The structures and details which are not necessary for understanding the invention and which are evident for anyone skilled in the art have been omitted from the figures in order to emphasize the characteristics of the invention.

In the description, the concept of an “open device” mainly refers to the fact that the mechanical structure of the device is opened in such a manner that at least two frame parts are positioned next to each other. Correspondingly, the concept of a “closed device” mainly refers to the fact that the frame parts of the device are positioned substantially on top of each other or within each other. The functions of the device may case-specifically be on or off irrespective of whether the device is open or closed.

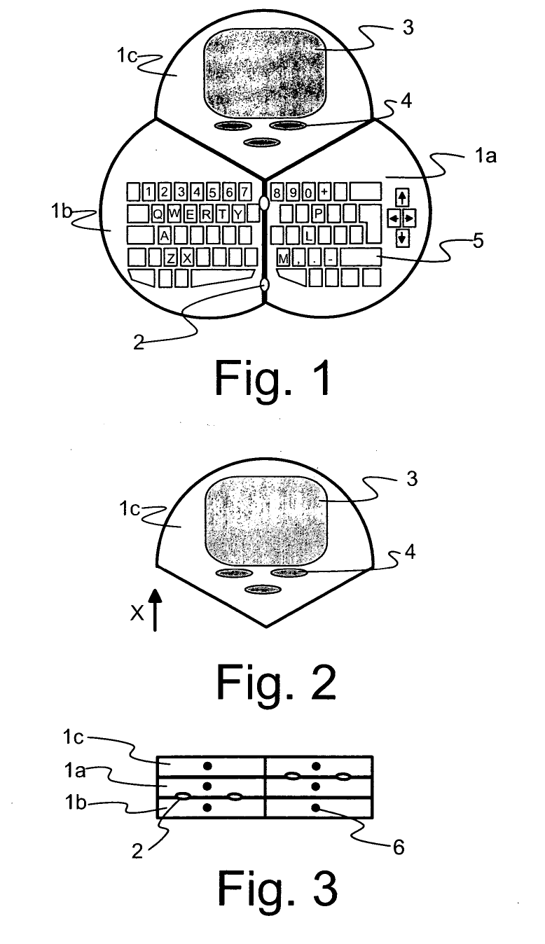

FIG. 1 shows a device structure according to the invention when the device is open. The device comprises three frame parts 1 arranged in movable relation to each other, of which parts the second part 1b and the third part 1c are connected to the first part 1a by means of hinges 2 or corresponding structures enabling the opening movement. In the embodiment shown in the figure, the second part 1b and the third part 1c are connected to the first part 1a by means of hinge structures 2 in such a manner that the angle between the axis lines of the hinge structures is 120 degrees. Thus, the angle between the opening directions of the second part 1b and the third part 1c is in turn 60 degrees. All three frame parts 1 are connected to each other when the device is open.

In the example according to FIG. 1, one frame part 1 comprises the display 3 of the device as well as some buttons 4, and in the other two parts is placed the keypad 5, in this case a qwerty-keypad. The keypad 5 can also be of some other type and/or the placement of the keys may differ from what is presented. It is also possible to place actuators or transducers in one, two or three frame parts 1. In an embodiment touch screens 3 are arranged in two frame parts 1 and in another embodiment touch screens 3 are arranged in three parts 1. In addition to displays 3, the actuators or transducers placed in the frame parts 1 of the device may include, among other things, keypads 5, buttons 4, loudspeakers and microphones.

The structures connected to the operation of the device, such as, for example, power sources, controllers, transmitters, receivers, memories, connectors, can be placed application-specifically into one or more frame parts 1.

FIG. 2 presents a device structure according to FIG. 1, in turn, in a closed position seen from the corresponding direction as in FIG. 1. Thus, the frame parts 1 are on top of each other by forming a bunch. The bunch-like placement of the frame parts 1 of the device can be seen in a more illustrative manner in FIG. 3, which presents the situation according to FIG. 2 in the “X” direction, i.e., an edge view, as seen from the direction X. In the example, the third frame part 1c is located on top of the first frame part 1a and the second frame part 1b is located below the first frame part, i.e. on the opposite side from the third frame part.

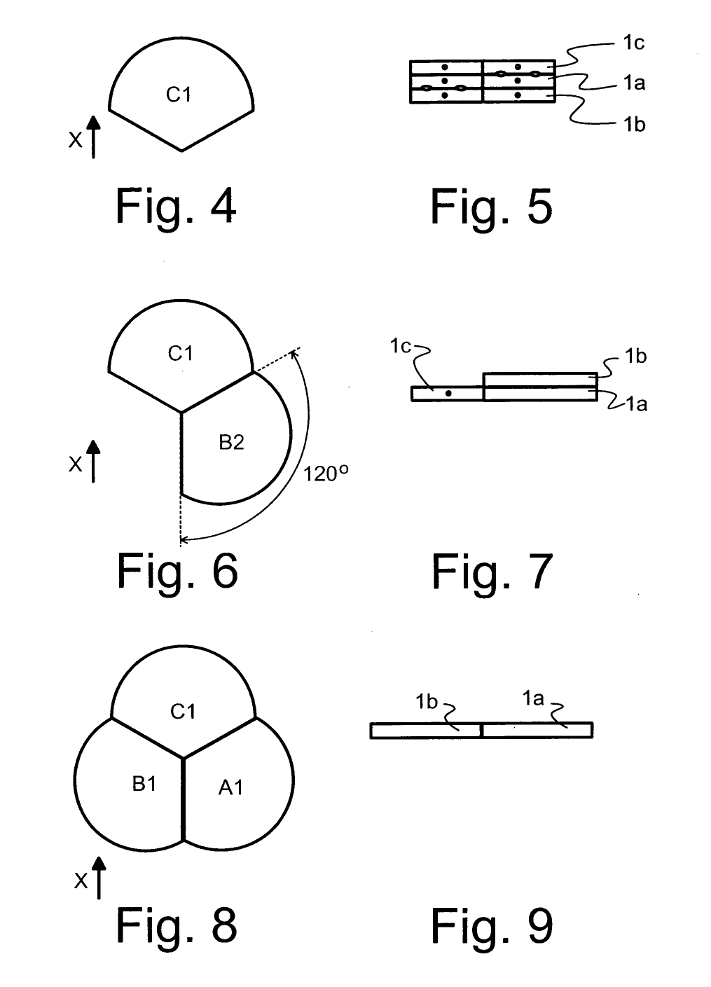

The series of figures formed by FIGS. 4 to 9 shows the phases connected to opening and closing the structure according to an embodiment of the invention. In the series of figures, FIG. 5 shows the embodiment according to FIG. 4 seen from the direction X, as well as in figure pairs 6 and 7, and 8 and 9. For the sake of clarity, additional references differing from other figures are used in the figure sequence in order to specify the surfaces of the frame parts 1. In FIGS. 4, 6 and 8 the first surface of the first frame part 1a is marked with A1 and the second surface with A2. Correspondingly, the first surface of the second frame part 1b is marked with B1 and the second surface with B2, and the first surface of the third frame part 1c is marked with C1 and the second surface with C2.

In figure pair 4 and 5 the device is closed, in which case the first surface C1 of the third frame part 1c is visible to the user (seen from the direction according to FIG. 4).

In FIGS. 6 and 7 two other frame parts 1a, 1b are folded from under the third frame part 1c next to the third part in such a manner that the first surface C1 of the third part 1c and the second surface B2 of the second part 1b are visible. The second frame part 1b and the first frame part 1a are on top of each other in such a manner that the first surfaces B1 and A1 are opposite each other. Next, the second frame part 1b is moved from on top of the first frame part 1a to a position that can be seen in FIGS. 8 and 9. Thus, the first surface A1 of the first part 1a, the first surface B1 of the second part 1b and the first surface C1 of the third part 1c are visible. In the example, all three frame parts 1a, 1b and 1c set next to each other in such a manner that their first surfaces 1a, 1b and 1c form a substantially uniform and even surface. All three frame parts 1a, 1b and 1c are as thick as each other in the example, in which case a substantially evenly thick structure is formed by the opened device. It is, however possible to, if necessary, form the different frame parts 1 as different in their thickness and/or fluctuating in their surface profile.

In the above-presented embodiments the frame parts 1 are uniform in such a manner that the sides setting on top of each other in the closed form substantially correspond to each other in their form. Thus, the appearance of the device substantially corresponds to the form of a single frame part 1, as can be detected in FIGS. 2 and 4. In the example, the thickness of the device corresponds to the combined thickness of the overlapping parts 1, as can be detected, for example, in FIGS. 3 and 5.

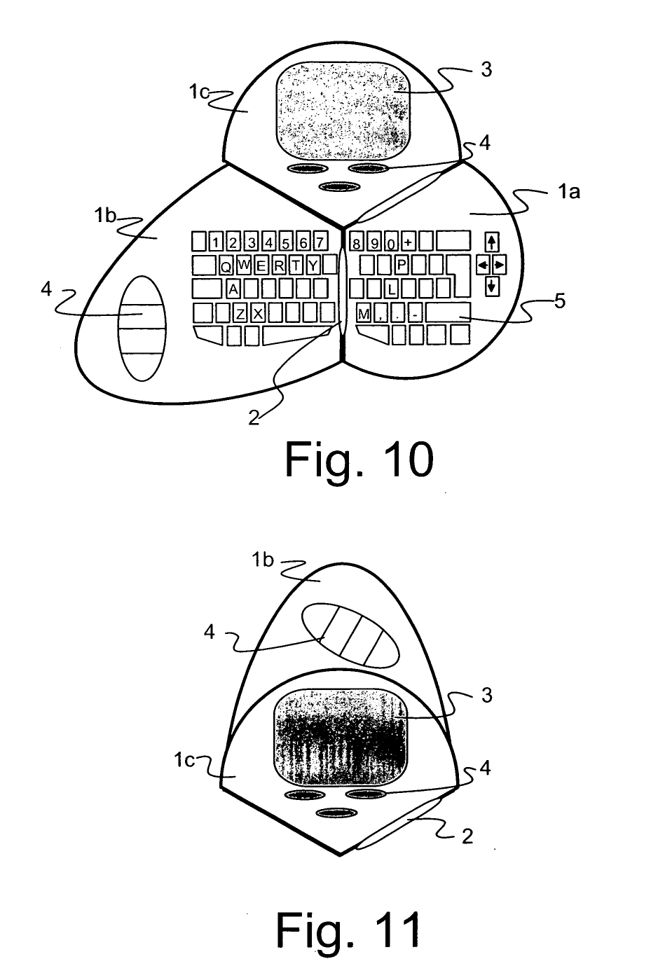

It is also possible to form at least one frame part 1 in a different form than the other frame parts. Thus, in such embodiments the frame parts 1 do not set entirely on top of each other in the closed form of the device. For example, FIGS. 10 and 11 show such an embodiment. In the example, one of the frame parts 1b of the device is larger in its area than the two other frame parts 1a, 1c. In FIG. 10 the structure is presented open and in FIG. 11 closed. As can be detected from the figures, in this example a part of the buttons 4 of the user interface in the second frame part 1b can be reached by the user both when the device is open and when the device is closed.

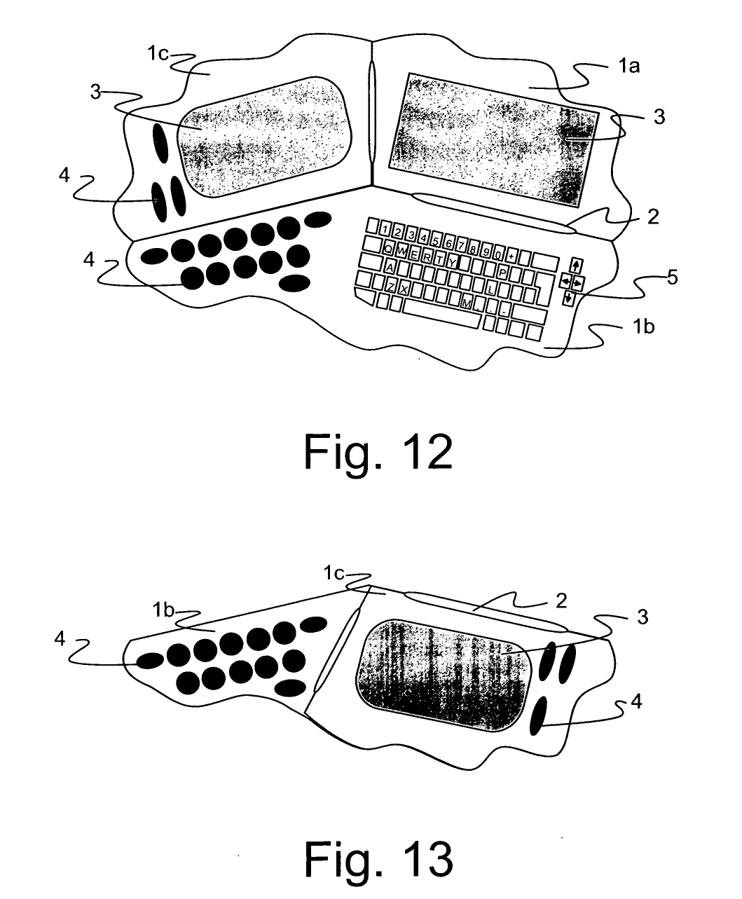

In the above-presented embodiment, the angle between the axis lines of the opening structures 2, such as, for example, hinge structures, is substantially 120 degrees, which is marked in FIG. 6. An angle of the size in question between the hinge structures 2 enables, among other things, the embodiment described above in FIGS. 1 and 2, where the appearance of the closed device corresponds substantially to the form of an individual frame part 1. FIGS. 12 and 13 show an embodiment, where the angle between the hinge structures 2 is not 120 degrees. The frame parts 1 of the structure in question are connected to each other when the device is open, as shown in FIG. 12. When closing the device, the frame parts 1 do note set entirely on top of each other, as FIG. 13 presents. In the embodiment according to FIGS. 12 and 13 one frame part 1b is larger than the other frame parts 1a, 1c, in which case when the device is closed, some of the surface of this largest frame part remains visible on the background of the other frame parts setting on top of it. As can be detected from FIGS. 12 and 13, the buttons 4 of a user interface placed on this kind of an area can be reached by the user both when the device is open and when the device is closed.

The size of the angle between the axis lines of the opening structures 2, such as, for example, hinge structures, may vary a greatly depending on the application. For example, the size of the angle can be 70 to 170 degrees. In several embodiments the size of the angle is 100 to 140 degrees. Thus, the angle between the opening directions of the second frame part 1b and the third frame part 1c is 40 to 80 degrees. When the angle between the axis lines of the hinge structures 2 is substantially 120 degrees, the structure is possible to form as symmetric in the manner presented by FIGS. 1 and 2.

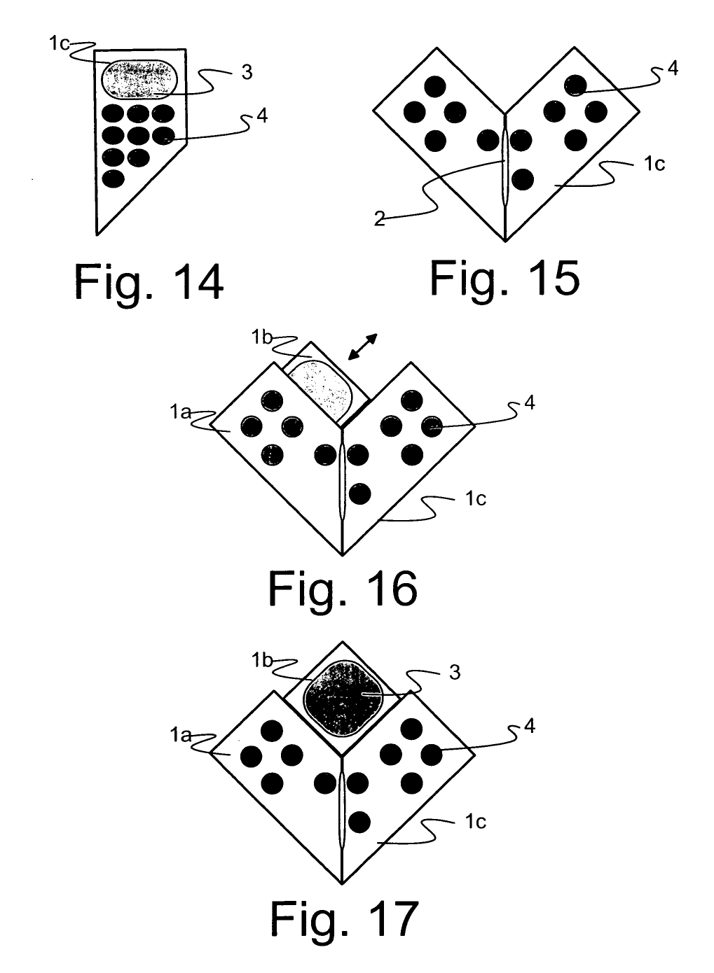

In the above examples the frame parts 1 are connected with hinge structures 2. It is possible to also use other kinds of opening structures 2 for connecting frame parts 1. FIGS. 14 to 17 show an embodiment of the invention, where the first opening device 2 is a hinge structure and the second opening structure is a slide structure. The presented slide structure 2 enables the linear movement of the frame part 1c. In FIG. 14 the device is in a closed position, in which case the user has access to the first user interface. In FIG. 15 the device is presented in a mid-position, where two frame parts 1a, 1b connected by a hinge structure 2 have been set next to each other. In FIG. 16 the third frame part 1c within the first frame part 1a has been slid partly outside the first frame part 1a. FIG. 17 shows the device in an open position, in which case all three frame parts 1a, 1b, 1c are set in the vicinity of each other. It is naturally possible to open the device in an order differing from what is presented above, such as, for example, by sliding the third frame part 1c open first. The opening structure 2 is also possible to be implemented in several different ways. For example, a slide structure may enable the sliding of frame parts 1 on top of each other or within each other.

In the above-presented examples the buttons 4 are arranged on the main surfaces of the frame parts 1. The buttons 4 as well as other means can be positioned in other manners as well. For example, in an embodiment a part of the buttons 4 are placed on the side surface of one or more frame parts 1. Thus, the buttons 4 can be used even if the device is closed.

In an embodiment the open and/or closed frame parts 1 lock to each other with locking means 6, such as, for example, magnets, which are shown in FIGS. 3, 5, 7 and 9. In another embodiment, in turn, the position of the frame parts 1 is detected by means of a position detection means. In an embodiment the locking means 6 and the position detection means are compound-structured, in which case it is possible to both lock the structure and to form data on the mutual position of the parts of the structure with the same means. The position data can, in turn, be used for several different purposes. In an embodiment the user interface of the device is activated by opening the device from the closed position to the open position. Thus, for example, by opening the device, the displays 3 and/or keypads 4, 5 are controlled on and/or open. Correspondingly, by closing the device the displays 3 and/or the keypads 4, 5 are controlled off and/or hidden. The effect achieved by opening and/or closing the device depends naturally on the device and its usage applications, which may be connected to, for example, a phone call, writing, reading, playing, i.e. what the user wants to do with his/her device.

In and embodiment the phone call functions of the device are activated on when one frame part 1 of the closed device is opened, such as, for example, to the position presented in FIGS. 6 and 7. Further, when opening the device entirely in such a manner that all three frame parts 1 are on a plane, the other functions are activated, which may be, for example, functions specified by the user or default functions.

Also, the presumed usage direction of the device can in an embodiment be specified on the basis of said position data and on the basis of this data the settings of the user interface are changed to correspond to the requirements of the usage direction. This kind of changeable values may include, for example, the viewing direction of the data presented on the display 3 and the control directions of actuators.

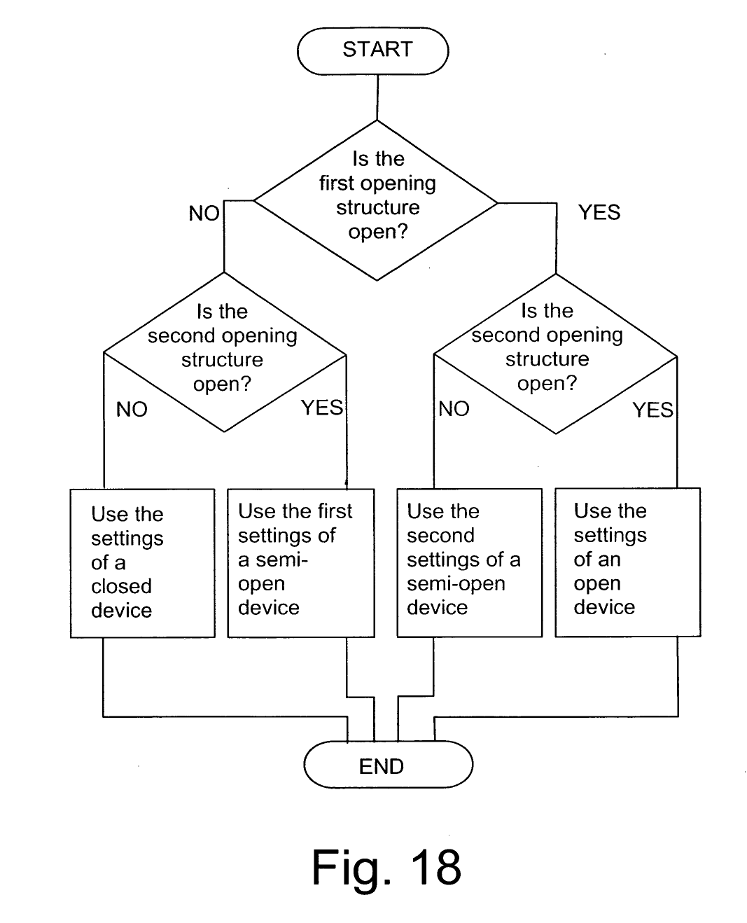

FIG. 18 shows the control principle based on the mutual positioning of the frame parts 1 of an embodiment according to the invention. In the example in question, the mutual location of the different frame parts 1 is determined on the basis of the state of the opening structures 2. First, it is determined whether the first opening structure 2 is open, i.e. if the surface of the first and third frame parts 1 are separated. Correspondingly, it is determined whether the second opening structure 2 is open, i.e. if the surfaces of the first and second frame parts 1 are separated. If both opening structures 2 are closed, the settings of a closed device are used in the example. When the first opening structure 2 is closed and the second opening structure is open, the first settings of the semi-open device are used. Correspondingly, when the first opening structure 2 is open and the second opening structure is closed, the second settings of the semi-open device are used. When both opening structures 2 are open, the settings of a open device are used in the example. The settings may concern several different properties of a device, such as, for example, the applications offered to the user or the characteristics of individual applications.

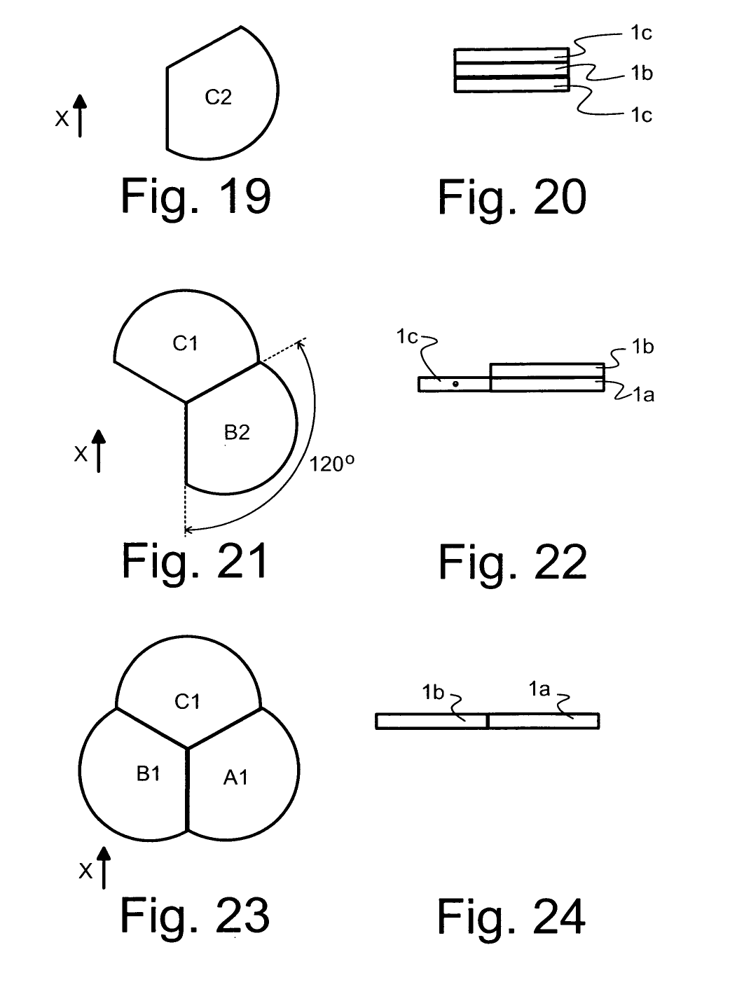

It is natural, that the different embodiments can be changed and applied in several different ways in the spirit of this invention. For example, the opening structures 2 are in the example presented to be placed in a certain manner. By changing the placement of the opening structures 2 onto different sides of the frame parts 1 than in the examples, it is possible to affect, among other things, the folding order, as well as the appearance of the transition forms of the opening and closing structure. For example, in an embodiment, the second frame part 1b and the third frame part 1c are connected to the first frame part 1a in such a manner that in the closed position of the device the second and the third frame parts can be positioned on top of each other. The operation of the embodiment in question is presented in the series of FIGS. 19 to 24. The opening structures are not presented in the figures, but the first frame part 1a and the third frame part 1c are connected to each other with an opening structure, which enables the placement of the second frame part 1b between the first and the third frame parts when the device is closed. The appearance can affect, for example, the usability of the device in some cases.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention may be freely varied within the scope of the inventive features presented in the claims hereinbelow.

1. An electronic device, which comprises at least
a first frame part, a second frame part and a third frame part, which are arranged movable in relation to each other,
a first opening structure, which is arranged to connect the first frame part to the second frame part, and
a second opening structure, which is arranged to connect the first frame part to the third frame part, and the first, second and third frame parts are arranged in such a manner that the device has at least two positions, of which
in a first, closed position the frame parts are substantially on top of each other and/or within each other,
in a second, open position the second frame part is transferred at least partly away from the first frame part by means of the first opening structure and the third frame part is moved at least partly away from the first frame part by means of the second opening structure,
wherein in the second, open position the second frame part and the third frame part of the device are arranged to be positioned in the vicinity of each other.

2. The device according to claim 1, wherein the second frame part and the third frame part have opening directions and the angle between the opening directions is 80 degrees.

3. The device according to claim 1, wherein the first opening structure is arranged to connect the second frame part to the first frame part in a rotating manner and the second opening structure is arranged to connect the third frame part to the first frame part in a rotating manner, and the angle between the rotation axis of the first opening structure and the rotation axis of the second opening structure is 70 to 170 degrees.

4. The device according to claim 1, wherein in the second, open position the second frame part and the third frame part are arranged to be positioned next to each other.

5. The device according to claim 1, wherein in the second, open position the second frame part and the third frame part are arranged to touch each other at least partly.

6. The device according to claim 1, wherein the device in addition comprises position detection means for detecting the position of the frame parts.

7. The device according to claim 1, wherein the device in addition comprises locking means for locking the mutual position of the frame parts in the second position of the device.

8. The device according to claim 1, wherein in the first position of the device the first surface of at least the third frame part forms the user interface of the device, and in the second position of the device, at least the first surface of the first frame part, the first surface of the second frame part and the first surface of the third frame part form the user interface of the device.

9. The device according to claim 1, wherein one or more frame parts comprise at least one of the following: a display, a touch screen, a keypad, a button.

10. The device according to claim 9, wherein two frame parts form the keypad assembly in the second position of the device.

11. The device according to claim 9, wherein the first surface of at least the third frame part comprises at least a display, which is in the use position when the device is in the first or second position.

12. The device according to claim 1, wherein the device is one of the following: a mobile communication device, a communication device, a computer, a camera, a game.

13. A method for controlling a user interface of an electronic device, which device comprises at least
a first frame part, a second frame part and a third frame part, which are arranged movable in relation to each other,
a first opening structure, which is arranged to connect the first frame part to the second frame part, and
a second opening structure, which is arranged to connect the first frame part to the third frame part, and the first, second and third frame parts are arranged in such a manner that the device has at least two positions, of which
in the first, closed position the frame parts are substantially on top of each other and/or within each other,
in the second, open position the second frame part is transferred at least partly away from the first frame part by means of the first opening structure and the third frame part is moved at least partly away from the first frame part by means of the second opening structure,
wherein in the second, open position the second frame part and the third frame part of the device are arranged to be positioned in the vicinity of each other, in which case the method comprises
detecting the position of the device and on the basis of the position data
controlling the user interface.

14. The method according to claim 13, wherein by changing the position of the device from the first position to the second position, or from the second position to the first position, a function of the user interface is set on or off.

15. The method according to claim 14, wherein the function is at least one of the following: a call, writing, reading, a game.

16. The method according to claim 13, wherein the frame parts of the device comprise actuators, whose state is controlled on the basis of the position of the device in such a manner that when the device is in the first position, the actuators of the first surface of at least the third frame part are activated, and when the device is in the second position, the actuators of the first surface of at least the first frame part, the first surface of the second frame part and the first surface of the third frame part are activated.

17. A computer program, which comprises commands for controlling a user interface of a device, which device comprises at least
a first frame part, a second frame part and a third frame part, which are arranged movable in relation to each other,
a first opening structure, which is arranged to connect the first frame part to the second frame part, and
a second opening structure, which is arranged to connect the first frame part to the third frame part,
and the first, second and third frame parts are arranged in such a manner that the device has at least two positions, of which
in the first, closed position the frame parts are substantially on top of each other and/or within each other,
in the second, open position the second frame part is transferred at least partly away from the first frame part by means of the first opening structure and the third frame part is moved at least partly away from the first frame part by means of the second opening structure,
wherein in the second, open position the second frame part and the third frame part of the device are arranged to be positioned in the vicinity of each other, in which case the program comprises at least commands
for detecting the position of the device,
for forming the position data, and
for controlling the user interface on the basis of the position data.

18. The computer program according to claim 17, wherein the program comprises commands for setting the functions of a user interface on or off when the position of the device is changed from the first position to the second position or from the second position to the first position.

19. The computer program according to claim 18, wherein the function is at least one of the following: a call, writing, reading, a game.

20. The computer program according to claim 17, wherein the frame parts of the device comprise actuators, and the program in addition comprises commands for controlling the functions of the actuators on the basis of the position of the device in such a manner that when the device is in the first position, the actuators of the first surface of at least the third frame part are activated, and when the device is in the second position the actuators of the first surface of at least the first frame part, the first surface of the second frame part and the first surface of the third frame part are activated.
